(19) United States
(12) Patent Application Publication
(10) Pub. No.: US 2013/0339426 A1
(43) Pub. Date: Dec. 19, 2013

(54) ELECTRONIC DEVICE AND MANAGEMENT METHOD OF ELECTRONIC MAP USING ELETRONIC DEVICE

(71) Applicant: HON HAI PRECISION INDUSTRY CO., LTD., New Taipei (TW)

(72) Inventors: GUAN-RU CHEN, New Taipei (TW); CHEN-LIANG LIANG, New Taipei (TW); CHUN-NAN YU, New Taipei (TW)

(73) Assignee: HON HAI PRECISION INDUSTRY CO., LTD., New Taipei (TW)

(21) Appl. No.: 13/894,452

(22) Filed: May 15, 2013

(30) Foreign Application Priority Data
Jun. 13, 2012 (TW) 101120999

(51) Int. Cl. H04L 29/08

(52) U.S. Cl. CPC H04L 67/141
USPC 709/203; 719/328

(57) ABSTRACT

An electronic device for managing an electronic map provides a service for accessing the electronic map of a first security system. The electronic device further includes an abstract electronic map layer embedded in the first security system and a second security system. The abstract electronic map layer embeds an uniform resource locator and a loading scheme of the electronic map in a first application programming interface (API) of the first security system and a second API of the second security system.

### BACKGROUND

1. Technical Field

The present disclosure is related to a data management method using an electronic device, and particularly related to a management method of an electronic map using the electronic device.

2. Description of Related Art

Electronic maps are commonly used for displaying relative locations of devices and areas in a security control zone. A security system is commonly embedded in an enclosed environment. Different security systems are executed independently even though the security systems monitor a same security control zone, such as a same office building of a same enterprise or a same organization, for example. Administrators of the different security systems need to compile pictures of the electronic maps of the same security control zone, which indicate that the pictures are repeatedly compiled.

Therefore, there is room for improvement within the prior art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is a schematic diagram of one embodiment of an electronic device having a management system of an electronic map.

FIG. 2 is an embodiment of an electronic device for managing an electronic map.

FIG. 3 is a flowchart of one embodiment of a management method of an electronic map using an electronic device.

### DETAILED DESCRIPTION

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

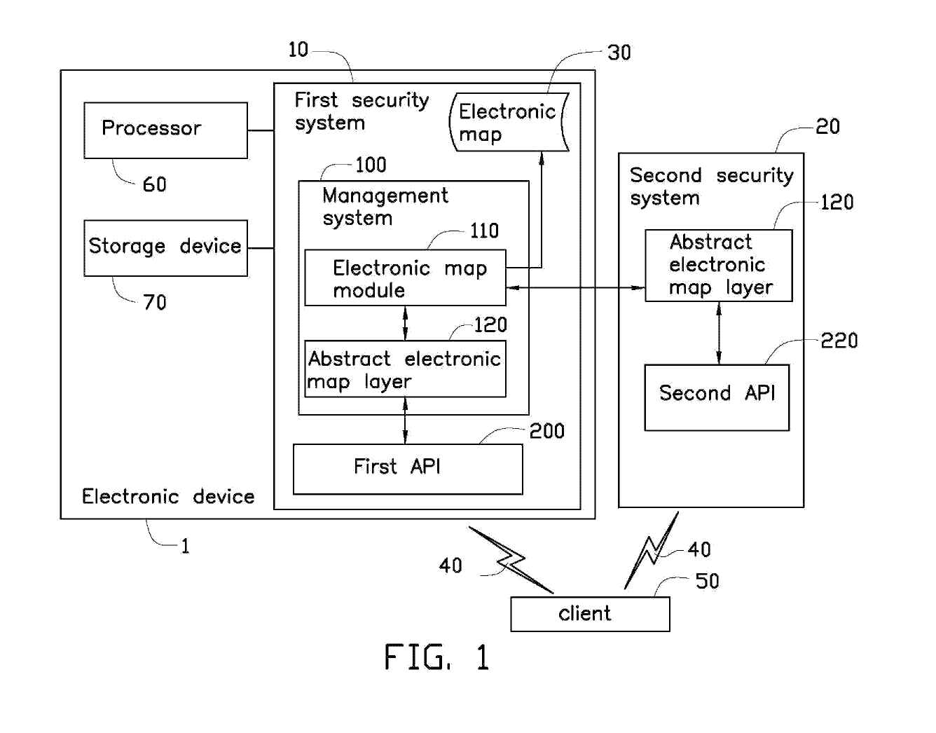

FIG. 1 is a schematic diagram of one embodiment of an electronic device 1. The electronic device 1 comprises an electronic map management system 100 that includes an electronic map module 110 and an abstract electronic map layer 120. The electronic map module 110 is embedded in a first security system 10, and the abstract electronic map layer 120 is embedded in the first security system 10 and a second security system 20. The first security system 10 further includes a first application programming interface (API) 200, and an electronic map 30. The first security system 10 and the second security system 20 are separately connected with a client 50 via a network 40.

The electronic map module 110 provides a service for accessing the electronic map 30 of the first security system 10. In this embodiment, the service is an API service. For example, the API service may upload pictures of the electronic map 30, check the picture of the electronic map 30, delete, and update the picture of the electronic map 30. The API service may further load, add, update, or delete the electronic map 30 or a node of the electronic map 30. Data of the electronic map 30 includes a plurality of pictures and multi-layer structures of the pictures. In security systems, the data of the electronic map 30 further include nodes of different system, such as fire sensors of a fire monitoring system or cameras of a video monitoring system can be the nodes of the electronic map 30, for example. For example, an electronic map 30 of A company B building, Longhua town, Baoan district, Shenzhen city includes at least one picture of the A company B building, and multi-layer map structures corresponded to the at least one picture. The at least one picture may be related to a map of Shenzhen city, a map of Baoan district, a map of Longhua town, a map of the A company, and a map of the B building. A video monitoring system of the A company may locate a plurality of cameras in the B building, and a fire monitoring system of the A company may locate a plurality of fire sensors in the B building. Locations of the cameras and the fire sensors are the nodes of the electronic map 30.

The abstract electronic map layer 120 embeds an uniform resource locator (URL) and a loading scheme of the electronic map in the first API 200 of the first security system 10 and a second API 220 of the second security system 20. For example, the electronic map 30 is embedded in the first security system 10. The loading scheme may be a scheme that the first API 200 of the first security system 10 accesses the electronic map 30 using the abstract electronic map layer 120 via an internal function, such as an API function, for example. The loading scheme may further be a scheme that the second API 220 of the second security system 20 accesses the electronic map 30 using the abstract electronic map layer 120 via a network protocol, such as a hypertext transfer protocol (HTTP), for example.

The electronic map module 110 and the abstract electronic map layer 120 include programming codes, saved in a storage device 70 of the electronic device 1. A processor 60 of the electronic device 1 executes the programming codes to provide functions of the electronic map module 110 and the abstract electronic map layer 120.

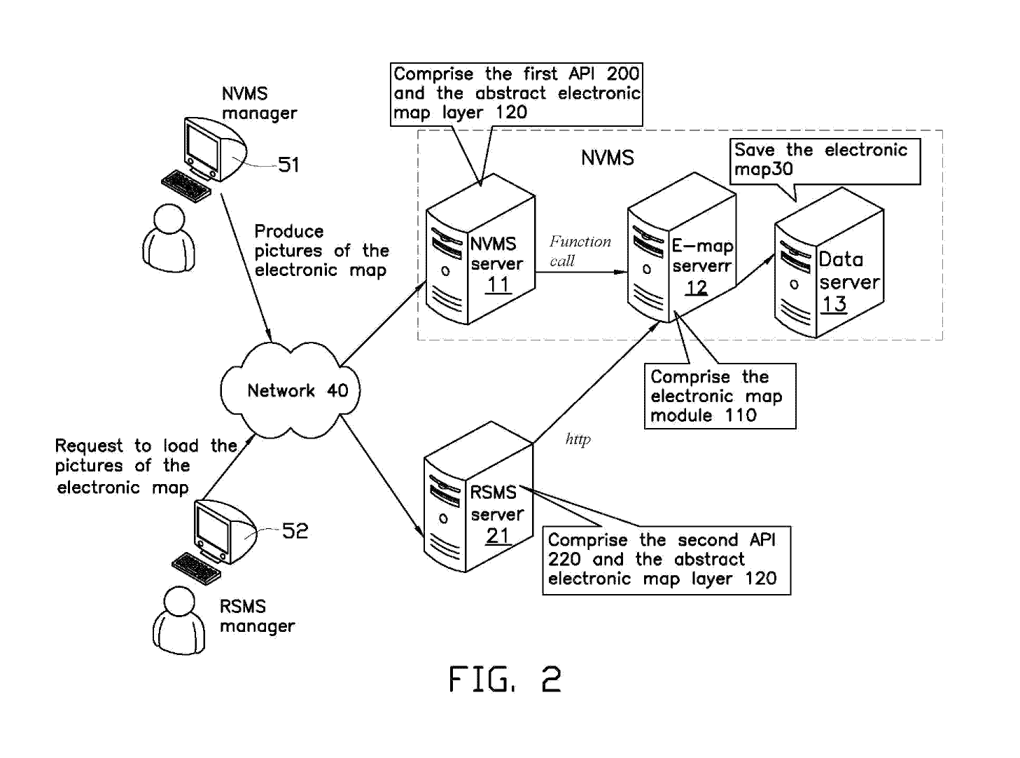

FIG. 2 is an embodiment of the electronic device 1 for managing the electronic map 30. In the embodiment, the first security system 10 is a network video management system (NVMS), and the second security system 20 is a remote sensor management system (RSMS). The electronic map module 110 is embedded in an electronic map server 12 of the NVMS. The abstract electronic map layer 120 is embedded in a NVMS server 11 of the NVMS and in a RSMS server 21 of the RSMS. The NVMS server 11 includes the first API 200 and the abstract electronic map layer 120. The RSMS server 21 includes the second API 220 and the abstract electronic map layer 120.

For example, the URL of the NVMS is “http://ms1.aaabbb.com”, and the URL of the RSMS is “http://ms2.aaabbb.com”. The electronic map module 110 is embedded in the electronic map server 12 of the NVMS, and the URL of the electronic map module 110 may be “http://ms1.aaabbb.com/emapserver”.

A NVMS manager produces a picture of the electronic map 30 at a client 51 of the NVMS, and transmits the picture to the NVMS server 11 via the network 40. The abstract electronic map layer 120 compares the URL of the electronic map module 110, such as “http://ms1.aaabbb.com/emapserver”, with the URL of the NVMS, such as “http://ms1.aaabbb.com”, to determine that the electronic map module 110 is embedded in the NVMS. The abstract electronic map layer 120 calls the electronic map module 110 using an internal function of the NVMS, and the electronic map module 110 uploads the picture to a data server 13.

A RSMS manager at a client 52 of the RSMS transmits a request for loading the picture of the electronic map 30 to a RSMS server 21 of the RSMS via the network 40. The abstract electronic map layer 120 compares the URL of the electronic map module 110, such as “http://ms1.aaabbb.com/emapserver”, with the URL of the RSMS, such as “http://ms2.aaabbb.com”, to determine that the electronic map module 110 is not embedded in the RSMS. The abstract electronic map layer 120 calls the electronic map module 110 using the HTTP. The electronic map module 110 downloads the picture of the electronic map 30 from the data server 13 and transmits the picture to the RSMS server 21. The network 40 may be a local area network (LAN), or a wide area network (WAN).

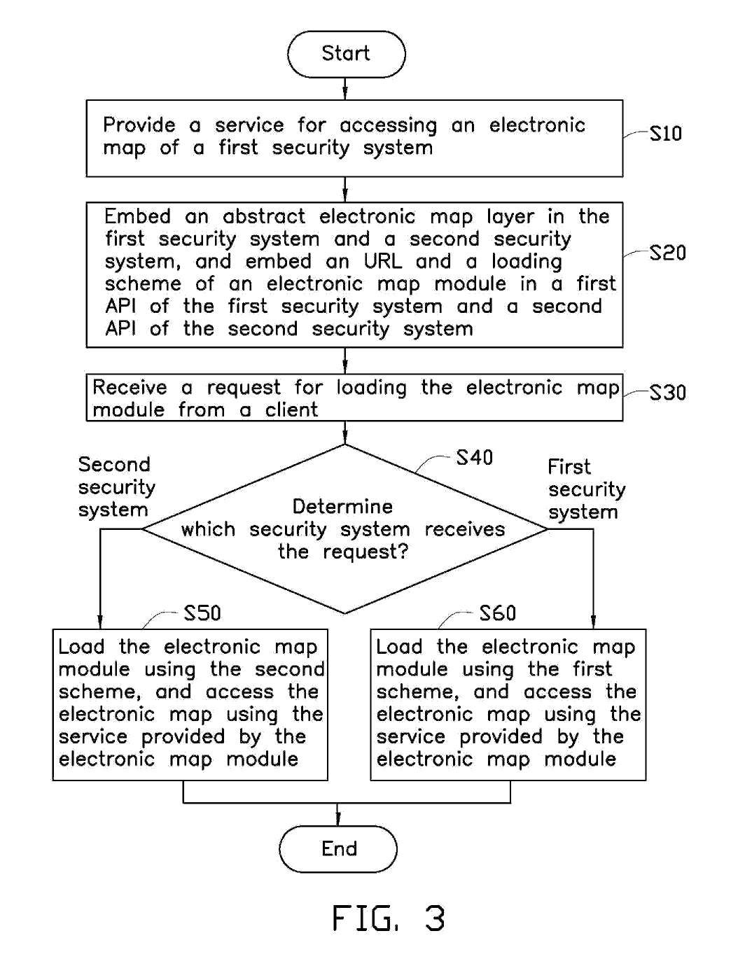

FIG. 3 is a flowchart of the embodiment of the management method of an electronic map using the electronic device 1.

In step S10, an electronic map module 110 is provided in a server of a first security system 10. The electronic map module 110 provides a service for accessing an electronic map 30 of the first security system 10, and then step S20 is implemented. The service may upload a picture of the electronic map 30, check the picture of the electronic map 30, delete, and update the picture of the electronic map 30. The service may further load, add, update, or delete the electronic map 30 or a node of the electronic map 30.

In step S20, an abstract electronic map layer 120 is embedded in the first security system 10 and a second security system 20. The abstract electronic map layer 120 embeds an URL and a loading scheme of the electronic map module 110 in a first API 200 of the first security system 10 and a second API 220 of the second security system 20, and then step S30 is implemented. For example, an URL of the first security system 10 is “http://ms1.aaabbb.com”, and an URL of the second security system 20 is “http://ms2.aaabbb.com”. The URL of the electronic map module 110 embedded in the first API 200 and the second API 220 is “http://ms1.aaabbb.com/emapserver”. The first security system 10 loads the electronic map module 110 using a first scheme, and the second security system 20 loads the electronic map module 110 using a second scheme. In the embodiment, the first scheme is an internal function of the first security system 10, and the second scheme is a network protocol, such as a HTTP. In another embodiment, the first scheme may be a scheme that can reduce complexity of a call of an internal application program, or can reduce a load of a server.

In step S30, an API of a security system receives a request for loading the electronic map module 110 from the client 50, and then step S40 is implemented. For example, the first API 200 of the first security system 10 or the second API 220 of the second security system 20 receives the request for loading the management system 100.

In step S40, the abstract electronic map layer 120 compares the URL of the electronic map with an URL of the security system that receives the request to determine which security system receives the request, the first security system 10 or the second security system 20. In the other words, the abstract electronic map layer 120 determines whether the electronic map module 110 is embedded in the security system that receives the request. When the security system that receives the request is the second security system 20, step S50 is implemented. When the security system that receives the request is the first security system 10, step S60 is implemented.

In step S50, the abstract electronic map layer 120 of the second security system 20 loads the electronic map module 110 using the second scheme, and accesses the electronic map 30 using the service provided by the electronic map module 110.

In step S60, the abstract electronic map layer 120 of the first security system 10 loads the electronic map module 110 using the first scheme, and accesses the electronic map 30 using the service provided by the electronic map module 110.

Depending on the embodiment, certain steps described may be removed, others may be added, and the sequence of the steps may be altered. It is also to be understood that the description and the claims drawn to a method may include some indication in reference to certain steps. However, the indication used is only to be viewed for identifier purposes and not necessarily as a suggestion as to an order for the steps.

The present disclosure is submitted in conformity with patent law. The above disclosure is the preferred embodiment. Any one of ordinary skill in this field can modify and change the embodiment within the spirit of the present disclosure, and all such changes or modifications are deemed included in the scope of the following claims.

What is claimed is:

1. A management method of an electronic map of a first security system, comprising:
providing a service for accessing the electronic map of the first security system; and
embedding an uniform resource locator (URL) and loading schemes of the electronic map in a first application programming interface (API) of the first security system and a second API of a second security system.

2. The management method of claim 1, further comprising:
receiving a request for loading the electronic map from a client;
determining which security system receives the request by comparing the URL of the electronic map with an URL of the security system that receives the request;
loading the electronic map using a first scheme, and accessing the electronic map using the service when the first security system receives the request; and
loading the electronic map using a second scheme, and accessing the electronic map using the service when the second security system receives the request.

3. The management method of claim 2, wherein the loading schemes are the first scheme and the second scheme, wherein the first scheme is an internal function of the first security system, and the second scheme is a network protocol, wherein the internal function is a function only can be used in the first security system.

4. The management method of claim 1, wherein the service is used to upload, check, update, and delete pictures of the electronic map, and the service is further used to load, add, update, and delete the electronic map and a node of the electronic map.

5. An electronic device comprising:
a storage device;
at least one processor; and
one or more modules stored in the storage device and executed by the at least one processor, the one or more modules comprising:
an electronic map module of a first security system configured to provide a service for accessing an electronic map of the first security system; and
an abstract electronic map layer embedded in the first security system and a second security system configured to embed an uniform resource locator (URL) and loading schemes of the electronic map in a first application programming interface (API) of the first security system and a second API of the second security system.

6. The electronic device of claim 5, wherein:
the abstract electronic map layer compares the URL of the electronic map with an URL of a security system that receives a request for loading the electronic map from a client to determine which security system receives the request;
the abstract electronic map layer loads the electronic map module using a first scheme, and accesses the electronic map using the service provided by the electronic module when the first security system receives the request; and
the abstract electronic map layer loads the electronic map module using a second scheme, and accesses the electronic map using the service provided by the electronic map module when the second security system receives the request.

7. The electronic device of claim 6, wherein the loading schemes are the first scheme and the second scheme, wherein the first scheme is an internal function of the first security system, and the second scheme is a network protocol, wherein the internal function is a function only can be used in the first security system.

8. The electronic device of claim 5, wherein the service is used to upload, check, update, and delete pictures of the electronic map, and the service is further used to load, add, update, and delete the electronic map and a node of the electronic map.

9. A non-transitory computer-readable storage medium having stored thereon instructions that, when executed by at least one processor of an electronic device, causes the electronic device to perform a management method of an electronic map of a first security system, the management method comprising:
providing a service for accessing the electronic map of the first security system; and
embedding an uniform resource locator (URL) and loading schemes of the electronic map in a first application programming interface (API) of the first security system and a second API of a second security system.

10. The storage medium of claim 9, wherein the management method further comprises:
receiving a request for loading the electronic map from a client;
determining which security system receives the request by comparing the URL of the electronic map with an URL of the security system that receives the request;
loading the electronic map using a first scheme, and accessing the electronic map using the service when the first security system receives the request; and
loading the electronic map using a second scheme, and accessing the electronic map using the service when the second security system receives the request.

11. The storage medium of claim 10, wherein the loading schemes are the first scheme and the second scheme, wherein the first scheme is an internal function of the first security system, and the second scheme is a network protocol, wherein the internal function is a function only can be used in the first security system.

12. The storage medium of claim 9, wherein the service is used to upload, check, update, and delete pictures of the electronic map, and the service is further used to load, add, update, and delete the electronic map and a node of the electronic map.
